(19) United States
(12) Patent Application Publication
(10) Pub. No.: US 2004/0085963 A1
(43) Pub. Date: May 6, 2004

(54) Method of organizing data packets

(75) Inventor: Thomas Man Yin Ying, Swindon (GB)

Correspondence Address: James M. Bagarazzi, DORITY & MANNING, P.A., P.O. Box 1449, Greenville, SC, 29602, US

(73) Assignee: ZARLINK SEMICONDUCTOR LIMITED

(21) Appl. No.: 10/444,787

(22) Filed: May 23, 2003

(30) Foreign Application Priority Data
May 24, 2002 (GB) 0212037.6

(51) Int. Cl. H04L 12/56

(52) U.S. Cl. 370/394

(57) ABSTRACT

A data buffer is disclosed which organizes data packets received from a data link. Each data packet has an associated index number indicating both the order in which the data packet was sent and the order in which that data packet is to be read out from the buffer. The data buffer is made up of plural memory areas, each area being capable of storing a single data packet at a time. Each received data packet is stored in one of the memory areas in accordance with the index number associated with the data packet. The data buffer may be used in conjunction with a data transmitter and a data processor that processes the data packets in real time.

### CROSS-REFERENCE TO RELATED APPLICATIONS

The present application claims priority to currently pending United Kingdom Patent Application number 0212037.6, filed on May 24, 2002.

### STATEMENT REGARDING FEDERALLY SPONSORED RESEARCH OR DEVELOPMENT

N/A

### BACKGROUND OF THE INVENTION

In a data communications system in which data packets are sent over a data link, e.g. a network connection, it is possible for the data packets to be received out of order and/or with timing inconsistencies between consecutively-received packets, i.e. jitter. These discrepancies can result in problems at a receiving end of the system since the data received may not a true representation of the data sent. Accordingly, it is often necessary to re-sort the received data packets so that they can be supplied to subsequent processing stages in correct order and/or with fewer timing problems. This sorting is usually performed in a memory device, sometimes referred to as a jitter buffer.

The Real-Time Transport Protocol (RTP) is an example of a data protocol enabling the transport of real-time data packets over a packet network, the RTP packets being sent in sequence across the network. Since RTP is often used on popular packet network protocols, such as the Internet Protocol (IP), the above-mentioned problems of desequencing and jitter frequently occur. In applications where real-time processing is needed, e.g. with an IP telephone in which the data packets represent real-time speech data, such problems can be highly problematic. Therefore, in order to receive the RTP packets over the IP connection, and process the RTP packets in real time, a jitter buffer is required to sort the RTP packets into order, and to smooth out their unpredictable arrival intervals.

A system employing a known jitter buffer is shown in FIG. 1. The system comprises a data transmitter 1 for transmitting data packets, e.g. RTP packets, a jitter buffer 3, and a real-time data processor 5 which processes the RTP packets. The data transmitter 1 transmits RTP packets to the jitter buffer 3 over an IP link 7. Some RTP packets are received by the jitter buffer 3 at unpredictable intervals and out of sequence. The jitter buffer 3 stores the RTP packets and sorts them into the correct sequence using a linked list method, as will be explained below. The real-time data processor 5 sends a data request message on a bus 9 to the jitter buffer 3 at regular time intervals. In response, the jitter buffer 3 sends an RTP packet to the real-time data processor 5 for each data request message received. Consequently, the real-time data processor 5 receives a steady stream of RTP packets in a corrected sequence.

The linked list method by which the conventional jitter buffer 3 operates will now be described with reference to FIG. 2. Referring to FIG. 2a, a received packet sequence is represented by the numbers “0”, “1”, “2”, “4”, and “3”. These numbers are actually intended to represent an index number associated with each packet, the index number indicating the sequence in which the packets were actually sent over the IP link. In other words, packet “0” is sent first and packet “4” is sent last. However, it will be seen that, in this case, packet “4” has been received before packet “3” and so desequencing has occurred somewhere over the IP link 7. When packet “0” is received, it is stored in a memory area, as indicated in FIG. 2b. Next, when packet “1” is received, it is stored in a new memory area which is linked to the previously-created memory area, as indicated in FIG. 2c. The same process happens when packets “2” and “‘4” are received, as indicated in FIG. 2d and 2e respectively. When packet “3” is received, the jitter buffer 3 recognizes that the index number “3” is less than the index number associated with a previously stored packet, i.e. packet “4”. As a result, the newly-created memory area storing the packet having the index, number “3” is linked between the memory areas storing the packets having the index numbers “2” and “4”. Also, the link between the memory area storing the packets having the index numbers “2” and “4” is broken. This is indicated in FIG. 2f.

As will be appreciated, each time a new data packet is received by the jitter buffer 3, the jitter buffer is required to search through the linked-list to determine if the new data packet has to be inserted between two previously-linked memory areas, and if so, where the data packet has to be inserted. The depth of the jitter buffer is also variable since, as more packets are received, the number of memory areas increases. The processing load is therefore heavy. Essentially, the method is cumbersome and certainly undesirable for real-time applications.

### Objects and Summary of the Invention

According to a first aspect of the invention, there is provided a method of organizing data packets received over a data link, each data packet having associated therewith an index indicative of the order in which that respective data packet is required to be outputted, the method comprising providing a buffer having a plurality of memory areas, each memory area being capable of storing a single data packet at a time, whereby each received data packet is stored in a predetermined one of the memory areas in accordance with the index associated with that respective data packet.

Since the memory area in which each data packet is stored is dependant on the index associated with each data packet, and since the index is indicative of the order in which each respective data packet is required to be outputted, it follows that the data packets can be stored in memory areas which reflect the order in which they are required to be outputted. Unlike the linked list method, a newly received data packet is not automatically linked to the previously-received data packet. Furthermore, the list of all previously-received data packets do not have to be analyzed in order to decide if a newly-received data packet is out of sequence. The computational load is therefore reduced.

In the method, a data reading means may periodically read the data packets, from the respective memory areas in which they are stored, in the order in which the data packets are required to be outputted. Such a periodic reading operation enables transfer of the stored data packets, to a subsequent data processing stage, in the order in which they are intended to be outputted. The subsequent data processing stage can be a real-time data processing device, such as an IP telephone. The periodic reading operation removes timing inconsistencies, such as jitter, which can be introduced to a sequence of transmitted data packets by the data link.

Preferably, there are provided N memory areas and the indexes consist of M numbers, wherein N and M are integers, M≧N, and N>1. Thus, the buffer may be of fixed size “N”. The data packets may be stored in the memory areas in accordance with the result of M (Modulo N), where M is the index number of a received data packet. In this respect, it will be appreciated that the outcome of this expression is the remainder of the division of M by N. Thus, if M=6 and N=4, then the result of 6 (Modulo 4) is 2, since 6 divided by 4 equals 1 with remainder 2.

The index numbers may repeat after M data packets have been sent over the data link. In this case, each received data packet may be monitored to determine whether its associated index number is a repeat of a previously-received index number, the index numbers of data packets currently stored in the buffer being modified, in response to such determination, by means of adding an integer multiple of N to those index numbers. The step of determining whether the index number received is a repeat of a previously-received index number can be performed by detecting when the index number of the received data packet is less than the index number of the data packet received previously.

The difference between index numbers of two consecutively-received data packets may be monitored to determine whether data packets, required to be outputted between the two consecutively-received data packets, have not yet been received, the step of determining if a received index number is a repeat of previously-sent index number only being performed if the number of data packets not yet received exceeds a predetermined number. In this case, if it determined that (a) the number of data packets not received exceed the predetermined number, and (b) the received index number is not a repeat of a previously-sent index number, the buffer is reset.

Any successive data packet allocated to an occupied memory area may overwrite the data packet previously stored therein.

The above-described method can be applied to any data packet transfer protocol wherein packets have an associated index which is indicative of the order in which the packets are to be outputted. Preferably, the indexes are also indicative of the order in which the respective data packets were inputted to the data link.

As an example, RTP data packets have an associated index number referred to in the protocol standard as the “sequence number”. As each RTP data packet is transmitted over a data link, the respective sequence numbers of consecutively-transmitted packets increment. Accordingly, if the first data packet has the sequence number 0, the second may will have the sequence number 1, and so on up to sequence number 65535, after which the sequence number 0 is repeated.

According to a second aspect of the invention, there is provided a computer program stored on a computer usable medium, the computer program comprising computer readable instructions for causing a processing means of the computer to perform a method of organizing data packets received by the computer over a data link, each data packet having associated therewith an index indicative of the order in which that respective data packet is required to be outputted, the method comprising providing a buffer having a plurality of memory areas, each memory area being capable of storing a single data packet at a time, whereby each received data packet is stored in a predetermined one of the memory areas in accordance with the index associated with that respective data packet.

According to a third aspect of the invention, there is provided a data buffer arranged to organize data packets received from a data link, each data packet having associated therewith an index indicative of the order in which that respective data packet is required to be outputted from the data buffer, the data buffer comprising a plurality of memory areas, each memory area being capable of storing a single data packet at a time, the data buffer being arranged to store each received data packet in a predetermined one of the memory areas in accordance with the index associated with that respective data packet.

Additional objects and advantages of the invention will be set forth in part in the description that follows, and in part will be obvious from the description, or may be learned by practice of the invention. The objects and advantages of the invention may be realized and attained by means of the instrumentalities and combinations particularly pointed out in the appended claims.

The accompanying drawings, which are incorporated in and constitute a part of is this specification, illustrate at least one presently preferred embodiment of the invention as well as some alternative embodiments. These drawings, together with the description, serve to explain the principles of the invention but by no means are intended to be exhaustive of all of the possible manifestations of the invention.

### BRIEF DESCRIPTION OF THE DRAWINGS

FIG. 1 is a block diagram of a system employing a jitter buffer;

FIG. 2 is a schematic representation of a linked list jitter buffer operation;

FIG. 3 is a block diagram of a system employing a jitter buffer according to the invention;

FIG. 4 is a detailed block diagram of the jitter buffer shown in FIG. 3;

FIGS. 5(a)-(e) are schematic diagrams which are useful for understanding part of a jitter buffer algorithm;

FIG. 6 is a state transition diagram representing the algorithm by which the jitter buffer shown FIGS. 3 and 4 operates;

FIG. 7 is a flow diagram showing steps in a first state indicated in the state transition diagram of FIG. 6;

FIG. 8 is a flow diagram showing steps in a second state indicated in the state 25 transition diagram of FIG. 6; and

FIG. 9 is a flow diagram showing steps in a third state indicated in the state transition diagram of FIG. 6.

### DETAILED DESCRIPTION OF THE PREFERRED EMBODIMENTS

Reference now will be made in detail to the presently preferred embodiments of the invention, one or more examples of which are illustrated in the accompanying drawings. Each example is provided by way of explanation of the invention, which is not restricted to the specifics of the examples. In fact, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention cover such modifications and variations as come within the scope of the appended claims and their equivalents. The same numerals are assigned to the same components throughout the drawings and description.

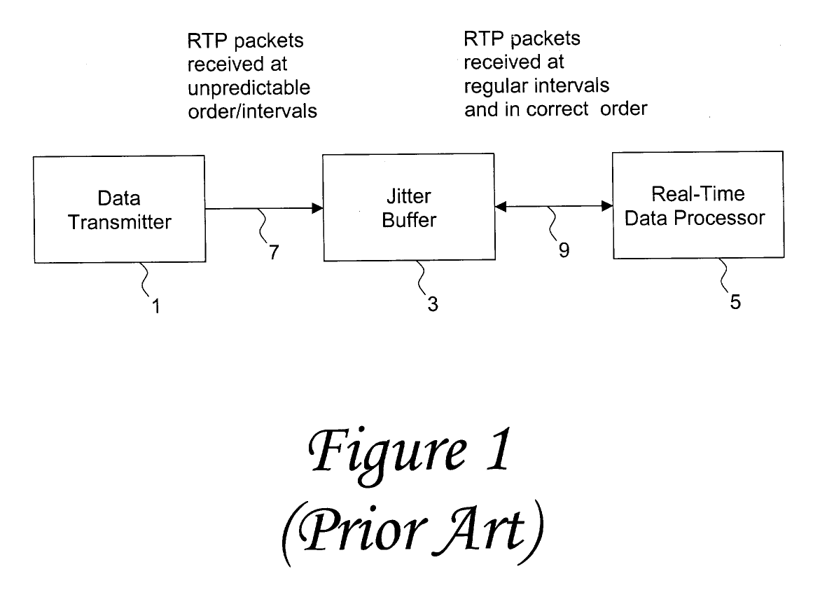

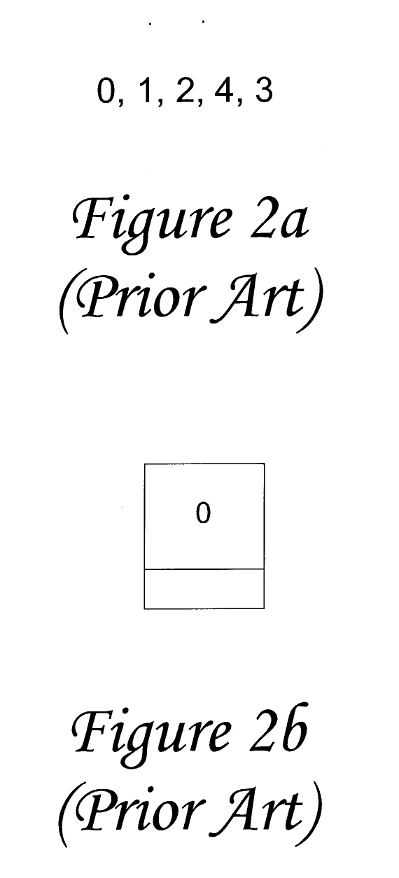

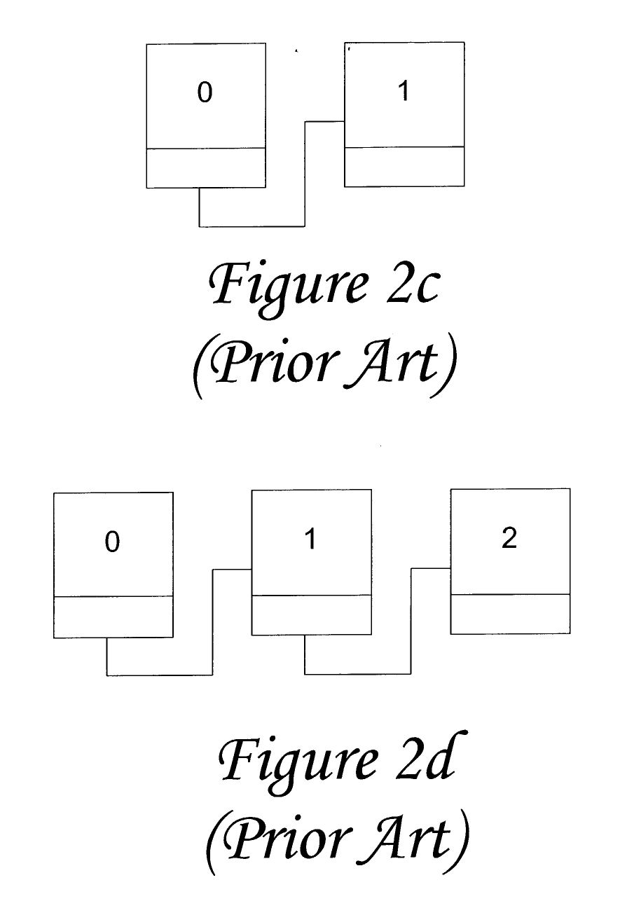

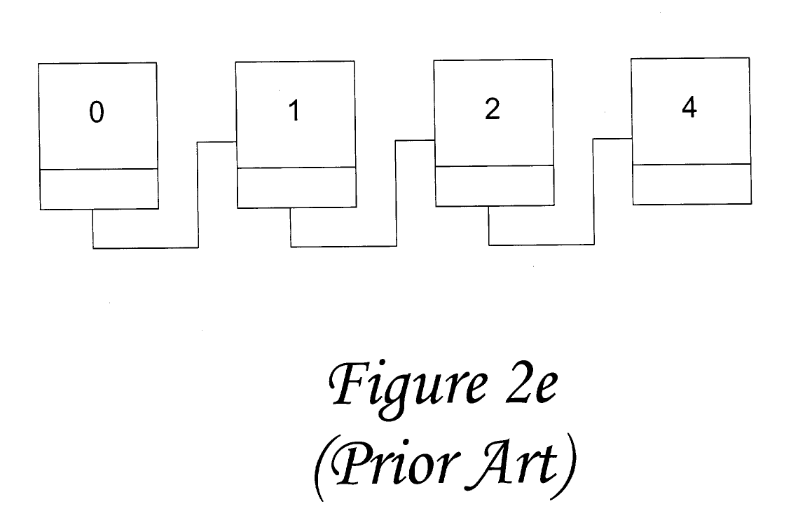

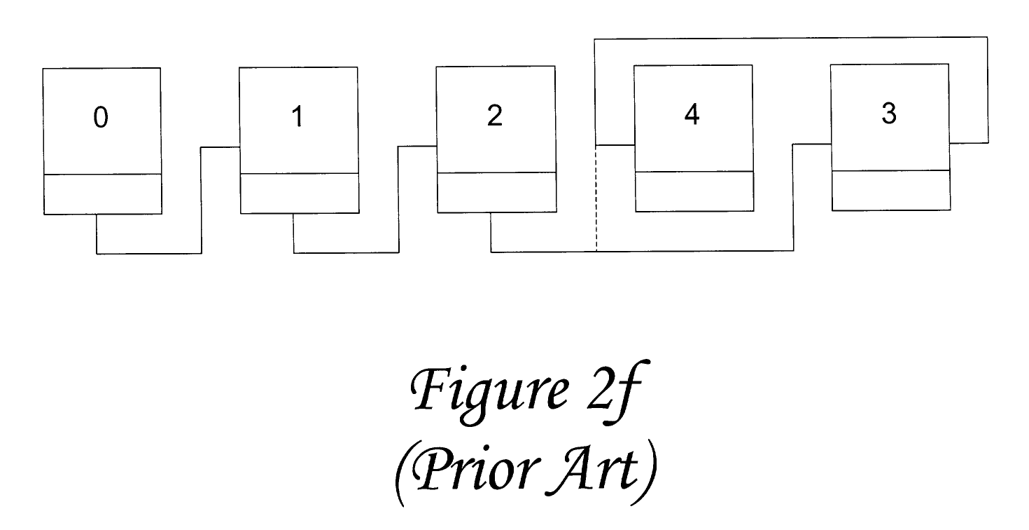

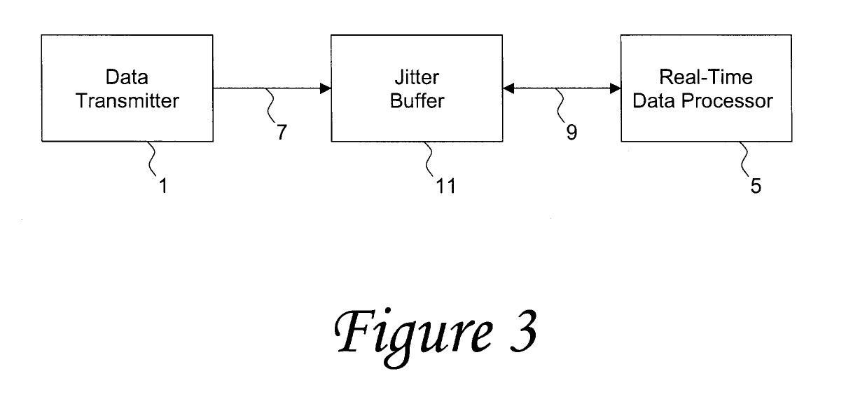

Referring to FIG. 3, a system employing a jitter buffer 11 in accordance with the invention is shown. The system comprises the data transmitter 1 and real-time data processor 5 shown in FIG. 1, the data transmitter being arranged to transmit RTP data packets to the jitter buffer 11 over the IP link 7. The real-time data processor 5 is arranged to periodically request RTP data packets from the jitter buffer 11 by sending a data request message over the bus 9. In response to each data request message received, the jitter buffer 11 is arranged to transmit a RTP packet to the real-time data processor over the bus 9. The method by which this is achieved will be explained below in greater detail.

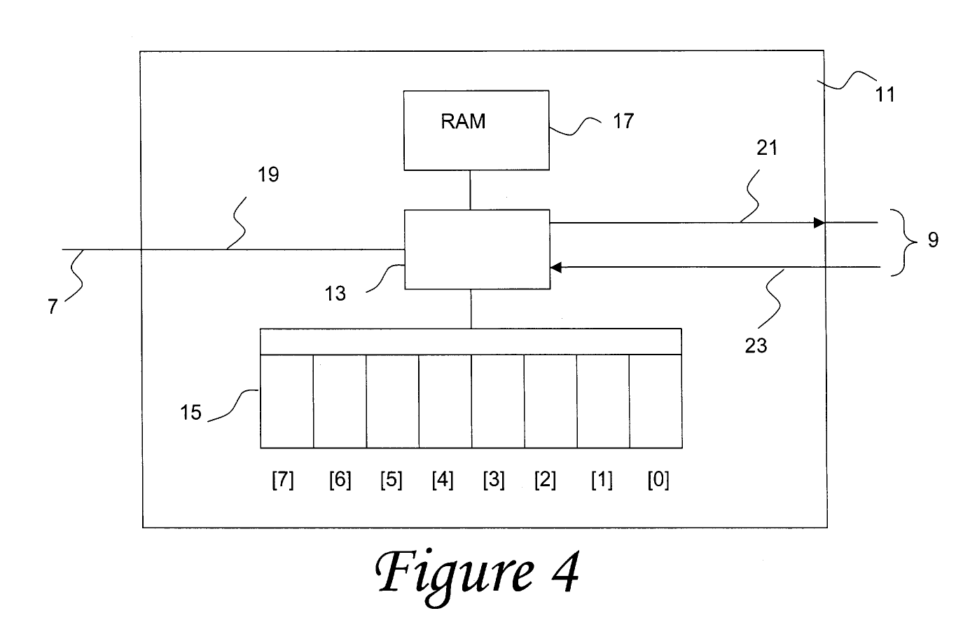

Referring to FIG. 4, which is a block diagram of the jitter buffer 11, it will be seen that the jitter buffer comprises a processor 13 connected to (i) a memory array 15, and (ii) a random access memory (RAM) 17. The processor 13 is connected to the IP link 7 by a data input line 19, and is connected to bus 9 using a packet output line 21 and a message request line 23. The real-time data processor periodically sends data request messages over the message request line 23, and in response, the processor 13 is arranged to output data packets over the packet output line 21. The memory array 15 is arranged as a number of separate memory areas. In FIG. 4, eight memory areas are shown, labeled “0” to “7”.

In use, the data transmitter 1 sends a stream of RTP data packets for subsequent processing by the real-time data processor 5. For example, the data transmitter 1 and the real-time data processor 5 may be the respective transmitting and receiving ends of an IP telephone. However, since the IP link 7 can introduce discrepancies in the packet stream, such as desequencing and jitter, the jitter buffer 11 is used to organize the received data packets into an improved order such that the ordered data packets can be sent to the real-time data processor 5 at a required, regular, rate.

Each RTP data packet sent from the data transmitter 1 has an associated index number, hereafter referred to as a “sequence number”. The sequence number associated with each data packet is indicative of the order in which that respective data packet is sent over the IP link 7. Thus, the initial data packet will have the sequence number “0”, the next data packet sent will have the sequence number “1,” and so on. According to the RTP standard, the highest sequence number used is “65535”. The data packet sent directly after will have the sequence number “0” and so the sequence numbers repeat for subsequently-transmitted data packets. Given that the sequence numbers indicate the order in which the RTP data packets are sent over the IP link 7, the jitter buffer is configured to use this sequence number information to organize the received data packets into a correct, or at least improved, order for subsequent periodic transmission to the real-time data processor 5. Specifically, a computer program is operated by the processor 13 of the jitter buffer 11, the computer program following an algorithm which will be fully explained below.

It will be understood that, in such a real-time application, the order in which data packets are sent over the IP link 7 will be the order in which they are required to be outputted to the real-time data processor 5.

The main principle by which the jitter buffer 11 organizes received RTP data packets is based upon a calculation in which data packets are stored in a particular one of the eight memory areas of the memory array 15 in accordance with the result of M (Modulo N), where M is the sequence number associated with each respective RTP data packet and N is the number of memory areas in the memory array 15. The outcome of this expression is the remainder of M divided by N.

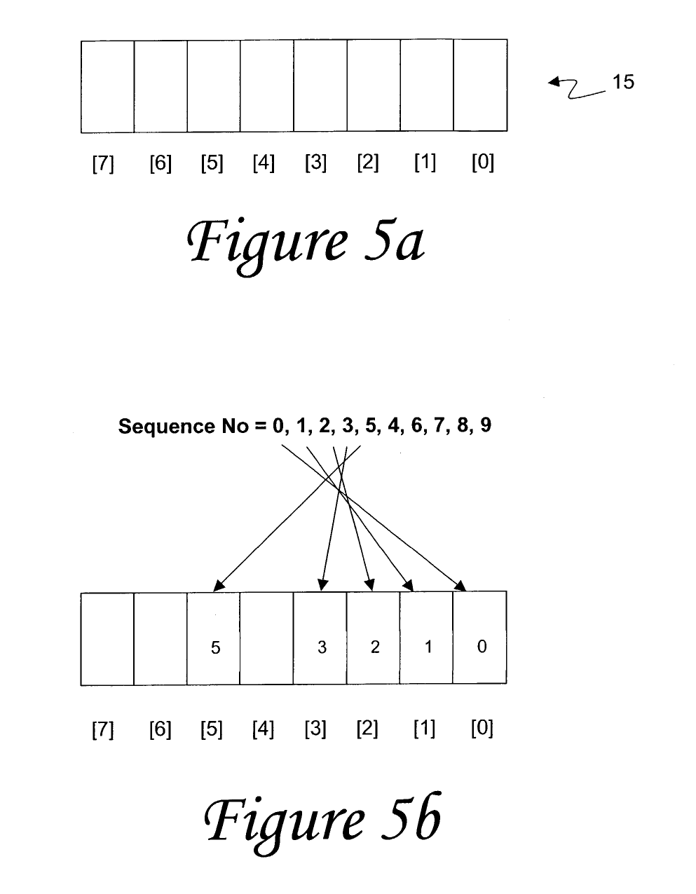

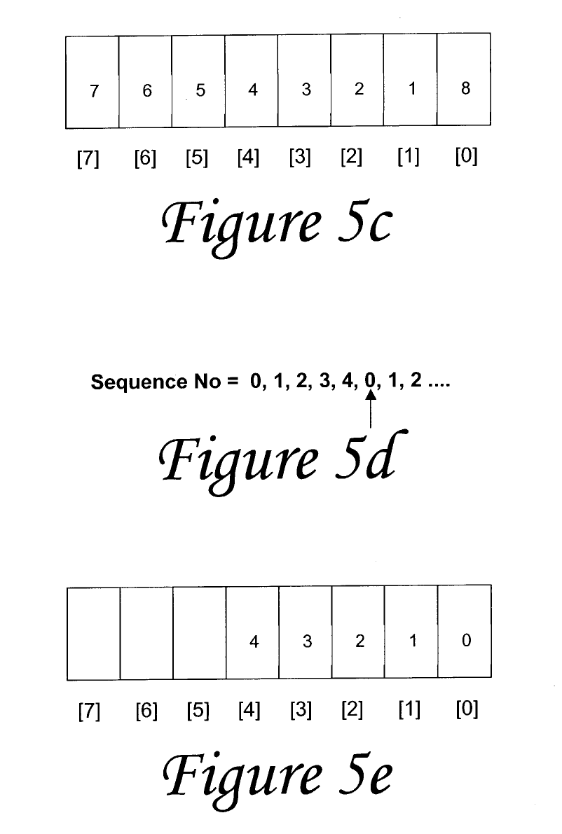

To demonstrate the principle, FIG. 5a shows the memory array 15 of the jitter buffer 11 shown in FIG. 4. The memory array 15 has eight memory areas and so N is “8“.

FIG. 5b represents the manner in which sequence numbers for a received RTP packet sequence are stored. It will be noted that the RTP packets having the sequence numbers “4” and “5” have been received out of order. When the first RTP packet is received, the result of 0 (Modulo 8) is “0” and so this RTP 30 packet is stored in the memory area “0”. When the next three RTP packets are received, it follows that the results of 1 (Modulo 8), 2 (Modulo 8) and 3 (Module 8) will be “1”, “2” and “3” respectively. Accordingly, these three data packets will be stored in memory areas “1”, “2” and “3.” When the next RTP data packet is received, since it has the sequence number “5” the result of 5 (Modulo 8) will be 5 and so this data packet will be stored in the memory area “5.” Memory area “4” is not used. When the next RTP packet is received, i.e. having sequence number “4”, the packet will obviously be stored in memory area “4”, since the result of 4 (Modulo 8) is 4. Thus, there is no re-sorting required in order to place this data packet in the appropriate place in the memory array 15.

The above process continues for the remainder of the RTP packet sequence. At the time when the RTP packet having the sequence number “8” is received, the result of 8 (Modulo 8) will be “0” again (since 8 divided by 8 leaves no remainder) and so this data packet will be stored in memory area “0”, i.e. by overwriting the data packet previously stored in this memory area. This situation is shown in FIG. 5c. However, the algorithm is arranged to ensure that a data packet will be transmitted to the real-time data processor 5, or discarded, before this overwriting operation happens.

By using the above M (Modulo N) calculation, it follows that a fixed number of memory areas can be used, instead of a continually increasing number of memory areas. This can be considered a ‘pigeonholing’ technique. The number of memory areas (sometimes referred to as the ‘buffer depth’) chosen for the memory array 15 will depend on the type of service requirements. In reality, the buffer 11 may require 500 memory areas for a practical IP link. If a near-perfect Intranet connection forms the link, then the buffer may only require 100 memory areas.

An interesting situation arises when a data packet having the highest available sequence number (i.e. “65535” in the case of RTP packets) is reached. This is because the next data packet will inevitably have a lower sequence number (“0” if the next data packet is not received out of sequence). This situation is referred to as “wraparound.” To demonstrate the principle, consider the sequence shown in FIG. 5d, and the memory array 15 shown in FIG. 5e. For ease of explanation, it is assumed here that the sequence numbers repeat after the number “4” is sent from the data transmitter 1. Thus, after a data packet is sent with the sequence number “4”, the next data packet has the sequence number “0”, as indicated by the arrow in FIG. 5d. When this happens, wraparound occurs. This condition is detected by the jitter buffer, as will be explained below, otherwise the next RTP data packet will be stored in memory area “0” rather than in memory area “5”. This can be problematic if the real-time data processor 5 has not yet received valid data stored in memory area “0”. On detecting a wraparound condition, an integer multiple of N (i.e. “8” in this case) is added to the sequence numbers before the process continues. This has the effect of shifting the sequence numbers ‘up’ and so subsequently received numbers will no longer have lower sequence numbers.

A further situation that the jitter buffer is configured to handle is a so-called “out-of-range discontinuity” condition. This occurs when a predetermined number of consecutive RTP data packets do not arrive in their expected positions in the received data sequence. This may be due to a large number of consecutive data packets being lost. By monitoring the sequence numbers as they arrive, and detecting when the difference between consecutively-received data packets is greater than a predetermined threshold, the jitter buffer 11 is configured to detect such an out-of-range discontinuity and to discard those missing packets as being lost.

The above-mentioned wraparound and out-of-range discontinuity tests are preferably performed prior to the M (Modulo N) organizing step. Indeed, as RTP data packets are received at the jitter buffer 11, they are temporarily stored in the RAM 17 so that the above-described tests can be performed. After this, the data packets are organized into their appropriate memory areas in the memory array 15.

Having summarized the main operations and tests to be performed by the jitter buffer 11, a more detailed explanation of the jitter buffer algorithm will now be described. As mentioned above, the algorithm is implemented by a computer program running on the processor 13, but can also be implemented in firmware.

The algorithm makes use of the following constants and variables for processing received RTP data packets. A brief explanation of the role of each constant/variable is also given, though their particular function will become clear from the following description.

### A. Constants

MAX_RTP_SEQ: Maximum sequence number for RTP (i.e. 65535).

BUF_DEPTH: Depth of the jitter buffer (based on the type of service requirements).

NO_PACKET: Constant used to indicate that a packet has not yet been received.

PACKET_UNREAD: Constant used to indicate that a packet has been received but has not yet been sent to the real-time processor 5.

PACKET_READ: Constant used to indicate that a packet has been sent to the real-time processor 5.

### B. Variables

RecvSeq: The sequence number of a newly-received RTP packet.

MostRecentSeq: The sequence number of the most recent RTP packet stored in the memory array 15 of the jitter buffer 11.

LeastRecentSeq: The sequence number of the least recent RTP packet stored in the memory array 15 of the jitter buffer 11.

SendSeq: The sequence number of the next RTP packet that should be sent to the real-time processor 5 for processing.

PacketStore[BUF_DEPTH]: Fixed-size jitter buffer storage.

PacketStatus[BUF_DEPTH]: Jitter buffer storage status.

PacketIndex: The index of the memory area to be used for storing the received RTP packet.

JitterThreshold: Threshold for controlling data flow.

JitterHysteresis: Hysteresis threshold.

JitterMax; Maximum jitter threshold value.

JitterMin: Minimum jitter threshold value.

JitterAdjTime: Jitter threshold adjustment period.

LateSeq: Number of packets that arrived too late for sending to real-time processor 5.

LateSeqLimit: Limit on the number of late packets received prior to adjusting the jitter threshold.

MaxDropOut: Limit on the number of dropout packets before the jitter buffer 11 is reset.

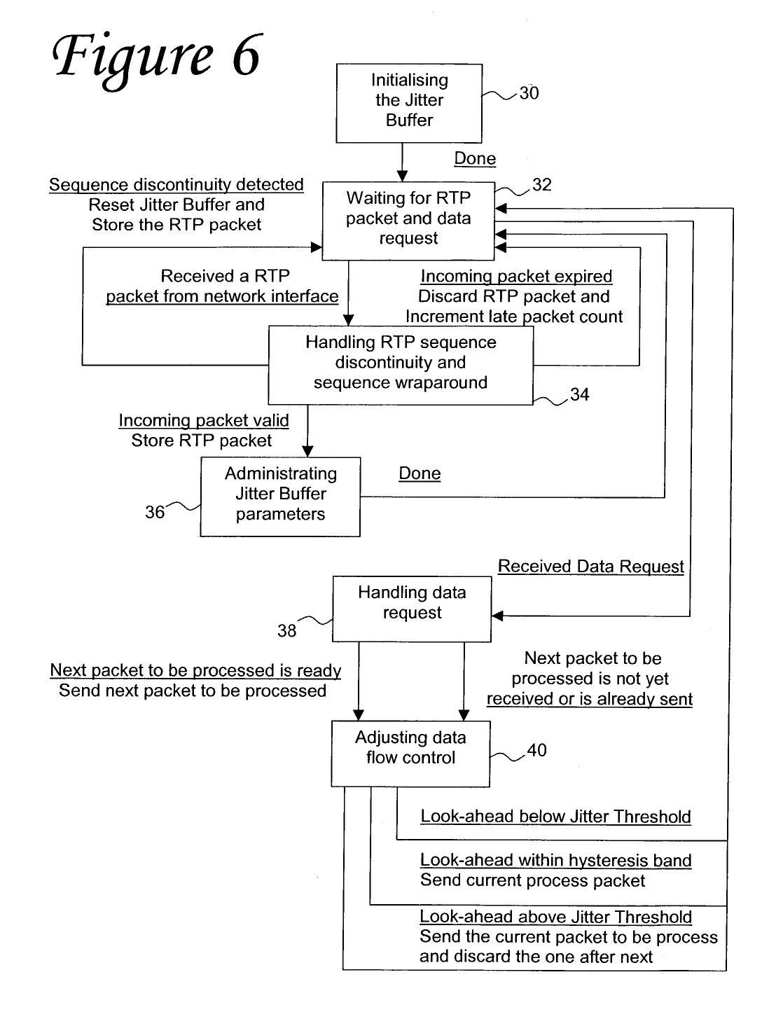

Referring to FIG. 6, which is a state transition diagram of the algorithm implemented in the jitter buffer 11, it will be seen that there are six states. In a first state 30 the jitter buffer 11 is initialized. Once this is done, the jitter buffer 11 enters a further state 32 in which either (i) the arrival of a new RTP packet, from the IP link 7, is awaited, or (ii) the receipt of a data request message from the real-time data processor 5 is awaited. On receipt of a new RTP packet, the jitter buffer 11 enters a new state 34 in which the main organization steps mentioned above are performed, e.g. the out-of-range discontinuity test, the wraparound test, and the packet organization step. Provided a valid RTP packet is received, that packet will be stored in an appropriate memory area of the memory array 15 and parameters (i.e. variables) of the jitter buffer 11 are administered accordingly in a further step 36. Once this is completed, a new RTP packet is awaited by re-entering step 32. If a non-valid data packet is received, e.g. the packet has expired because it is received too late, or an out-of-range discontinuity is detected, then the parameter administrating step 36 is not entered and the next RTP packet is awaited, again by re-entering the step 32.

If a data request message is received from the real-time data processor 5, the jitter buffer 11 enters the data request handling state 38 in which a data packet is read out from a memory area of the memory array 15. Depending on whether a requested RTP packet is validly sent, or is not because it has not yet been received or has already been sent previously, a data flow adjustment state 40 is then entered in which the data flow of the jitter buffer 11 is adjusted appropriately so as to ensure efficient transmission of subsequently-sent data packets. Once complete, the next RTP packet is awaited by re-entering step 32 again.

The operation of each state of the jitter buffer algorithm will now be described.

As mentioned, the first state 30 entered by the algorithm is the initialization of the jitter buffer 11. Essentially, this involves setting the jitter buffer variables to their initial values by:

1. Setting MostRecentSeq and LateSeq to zero;

2. Setting LeastRecentSeq to (MAX_RTP_SEQ−BUF_DEPTH+1);

3. Setting all PacketStatus bytes to NO_PACKET;

4. Setting JitterMax, JitterMin, JitterHysteresis, JitterAdjTime and LateSeqLimit to default values;

5. Setting JitterThreshold to any value between JitterMax and JitterMin; and

6. Setting SendSeq to (MAX_RTP_SEQ−JitterThreshold+1).

As indicated in the state transition diagram of FIG. 6, once state 30 has completed, the next step 32 is entered wherein the next RTP packet or data request message is awaited. In this state, if an RTP packet is received over the IP link 7, the jitter buffer will proceed to enter the state 34 whereby the main organization steps are performed.

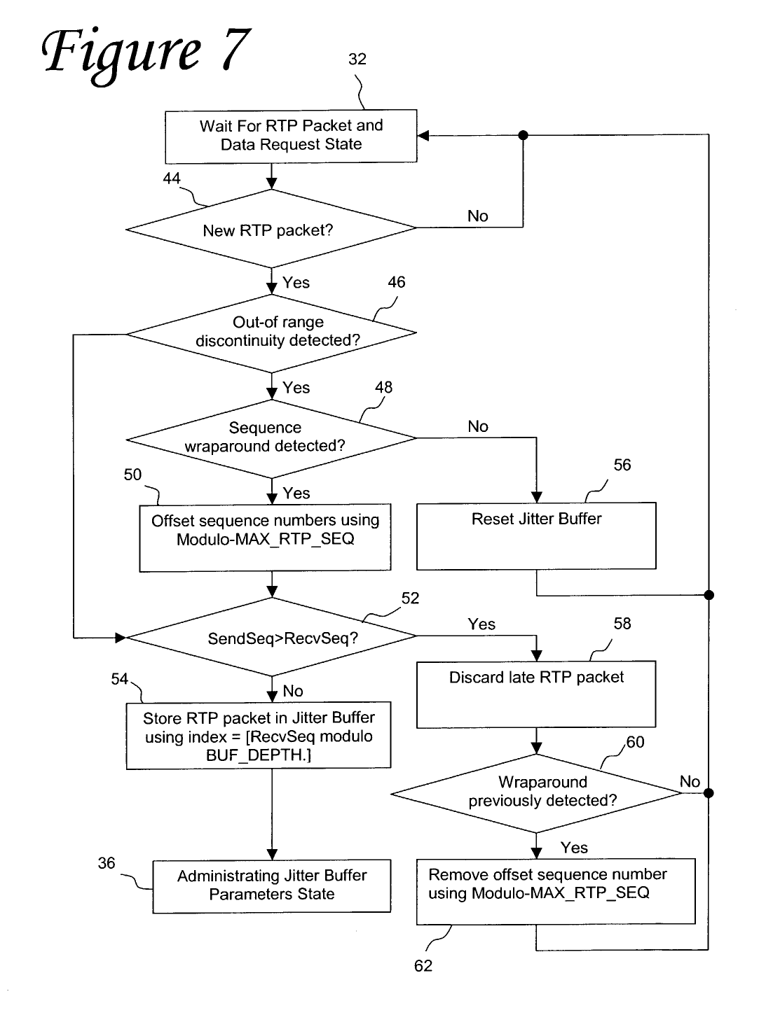

The steps of the algorithm performed in state 32 will now be described with reference to FIG. 7.

As indicated in FIG. 7, an initial loop is set-up in step 44 whereby if no RTP packet is received, the algorithm returns to the step 32 and so the process repeats. The following numbered steps indicate subsequent operations.

1. Once a new RTP packet is received, the algorithm compares the sequence number of the RTP packet (RecvSeq) with that of the most recently received (MostRecentSeq) and the least recently received (LeastRecentSeq) RTP sequence numbers recorded for RTP packets already stored in the memory array 15.

2. Next, in step 46, an out-of-range discontinuity test is performed, the principle of which has been described previously. In this algorithm, this occurs if the absolute value of (MostRecentSeq−RecvSeq) is greater than (MaxDropOut+BUF_DEPTH), and the absolute value of (LeastRecentSeq−RecvSeq) is greater than (MaxDropOut+BUF_DEPTH). If no out-of-range discontinuity is detected, then a further step 52 is entered (explained befow).

3. If an out-of-range discontinuity is detected, a further test is performed in step 48 to determine if a wraparound condition exists. Such a condition exists if RecvSeq is less than (MaxDropOut+BUF_DEPTH) and LeastRecentSeq is greater than MAX_RTP_SEQ−(MaxDropOut+BUF_DEPTH).

4. If a wraparound condition exists, then a wraparound mode is entered in step 50. The algorithm operates under this wraparound mode for all subsequently-received RTP data packets until the end of a wraparound condition is detected. In this respect, the wraparound condition exists when MostRecentSeq is less than LeastRecentSeq, and the wraparound condition ends when MostRecentSeq is greater than LeastRecentSeq.

5. In the wraparound mode, i.e. in step 50, the values of RecvSeq, MostRecentSeq, LeastRecentSeq, and SendSeq are offset so as to remove the wraparound condition by means of adding Q×BUF_DEPTH, wherein Q is an integer constant. The offset value should be in the range between (MaxDropOut+BUF_DEPTH) and (MAX_RTP_SEQ−1). Step 52 is then entered.

6. If no wraparound condition is detected in the step 48, then the algorithm resets the jitter buffer 11 in a further step 56 since all data stored in the memory array 15 is deemed expired due to the existence of the previously-detected out-of-range discontinuity. The jitter buffer 11 is reset by setting MostRecentSeq to RecvSeq, setting LeastRecentSeq to (RecvSeq−BUF_LEN+1) and setting SendSeq to (RecvSeq−Jitter Threshold+1). The received RTP packet is then stored in a memory area of the memory array 15 according to the M (Modulo N) determination summarized earlier. As will be appreciated, this is done by the calculation RecvSeq (Modulo BUF_DEPTH). The PacketStatus[PacketIndex] corresponding to that memory area is then set to PACKET_UNREAD to indicate the packet is ready for being read out to the real-time data processor 5. The algorithm then returns to the waiting state 32.

7. Following on from above, if no out-of-range discontinuity is detected in step 46, or after the offset operation is performed in step 50, step 52 is entered. In step 52, the validity of the received RTP packet is checked. If RecvSeq is less than SendSeq, the packet is deemed to have arrived too late for reading out to the real-time data processor 5 and so is deemed invalid. Accordingly, the RTP packet is discarded in a further step 58. Any offset introduced in the wraparound mode (step 50) is removed in steps 60 and 62, and the algorithm once again returns to the waiting state 32. If RecvSeq is not less than SendSeq, then the RTP packet is deemed valid.

8. If the RTP packet is deemed valid in step 52, the packet is stored in the memory array 15 in accordance with the M (Modulo N) calculation. In other words, the RTP packet is pigeonholed into the memory array, the storage index being equal to RecvSeq (Modulo BUF_DEPTH). The RTP packet is then transferred into the appropriate memory area using the calculated value of PacketStore[PacketIndex]. PacketStatus[PacketIndex] is then set to PACKET_UNREAD to indicate that the packet stored therein is ready to be sent to the real-time data processor 5 when a data request message is received. The algorithm then enters state 36 in which the various jitter buffer parameters are administered.

Following the main organization step examples described above (with reference to FIG. 5) a number of further examples are now described.

### EXAMPLE 1

### Detection of an Out-of-Range Discontinuity.

If we assume BUF_DEPTH is 16, MaxDropOut is 16, and the received sequence numbers of an RTP packet sequence are 0, 1, 2, 3, 4, 67, 68, 69, then an out-of-range discontinuity will be detected when the packet having sequence number 67 is received. Referring to the equation mentioned above with regard to step 46 of the algorithm, the absolute value of MostRecentSeq (i.e. 4) minus RecvSeq (i.e. 67) will be 63 which is greater than 32 (MaxDropOut+BUF_DEPTH). Also, the absolute value of LeastRecentSeq (i.e. 0) minus RecvSeq (i.e. 67) will be 67 which is again greater than 32. However, no sequence wraparound occurs (which will be understood by following the equation detailed above with regard to step 48).

### EXAMPLE 2

### Detection of Wraparound.

If we assume BUF_DEPTH is 16, MaxDropOut is 16, Q is 10 and the received sequence numbers of an RTP packet sequence are 65533, 65334, 65535, 0, 1, 2, 3 then a sequence wraparound is detected at the time when the RTP packet having sequence number 0 is received. Again, this will be understood by performing the equation detailed above with regard to step 48. As a result, the sequence numbers are offset by (Q×BUF_DEPTH) using Modulo MAX_RTP_SEQ before any further processing continues. Thus, the offset is equal to 160 and so the offset sequence numbers will be 157, 158, 159, 160, 161, 162, and 163.

### EXAMPLE 3

### Organization of out of sequence RTP packets.

As mentioned above, this is performed using the equation M (Modulo N), or to use the terminology of the algorithm, RecvSeq“(Modulo BUF_DEPTH). Thus, if BUF_DEPTH is 16, MaxDropOut is 16 and the sequence 20, 21, 22, 25, 23, 24 is received, then packets 20, 21, and 22 will be stored in memory areas having assigned index numbers “4”, “5”, and “6” respectively. Upon receipt of the packet having sequence number 25, no out-of-range discontinuity is detected (since MaxDropOut is 16) and the RTP packet is stored in a memory area having index number “9.” Packets having the sequence numbers 23 and 24 will be stored in memory areas “7” and “8” respectively.

As mentioned previously, the above organization tests and operations are performed prior to storing the currently-received RTP packet (RecvSeq) in the appropriate memory location of the memory array 15. For this purpose, the received RTP packet is transferred to the RAM 17 whereafter the above organizations tests and operations are performed.

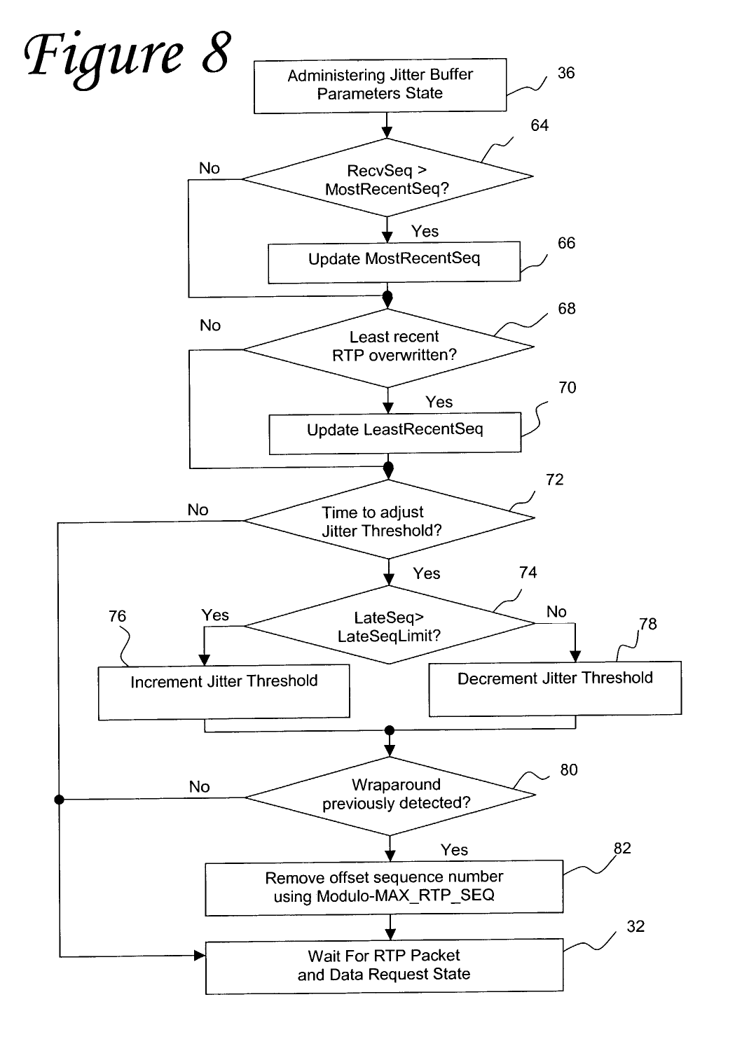

The steps involved in performing administration of the jitter buffer parameters, i.e. in state 36, will now be described with reference to FIG. 8. This state is entered only if a valid RTP packet is stored in the memory array 15.

In an initial step 64, it is determined if RecvSeq is greater than MostRecentSeq. If this is the case, then in step 66, MostRecentSeq is updated so that it equals RecvSeq. In other words, the current sequence number now become MostRecentSeq and the sequence number of the next received packet will be RecvSeq. In step 68, if it is determined that the current RTP packet overwrites the least recent RTP packet in the memory array 15, indicated by LeastRecentSeq<(MostRecentSeq−BUF_DEPTH+1), then LeastRecentSeq is updated to (MostRecentSeq−BUF_DEPTH+1) in step 70.

In step 72, if there is available time to adjust the current value of the JitterThreshold (depending on whether new RTP packets are being received) then the accumulated number of late packets (LateSeq) is monitored. As mentioned previously, packets are ‘late’ if RecvSeq is less than SendSeq. If so, then in step 74 it is determined whether the accumulated number exceeds the predefined value of LateSeqLimit over the predefined time period JitterAdjTime. If so, then in step 76, the current value of JitterThreshold is incremented. If not, then in step 78, the current value of JitterThreshold is decremented. JitterThreshold is bounded between JitterMax and JitterMin.

Following the adjustment steps, in step 80, it is determined whether a wraparound condition existed. If so, then the offsets introduced to the sequence numbers in the previous state (i.e. to add Q times BUF_DEPTH) are removed in step 82 using Modulo MAX_RTP_SEQ. The waiting state 32 is then re-entered following this offset removal. The waiting state 32 is re-entered directly if there is no available adjustment time determined in step 72, or if there was no wraparound condition detected in step 80.

The steps performed by the algorithm in the data request handling state 38 will now be described. As mentioned, this state is entered when a data request message is received from the real-time data processor 5. After a data request message is received, if the next RTP packet corresponding to SendSeq is already received and stored in the memory array 15 of the jitter buffer 11 (indicated by PacketStatus for that data packet being equal to PACKET_UNREAD) then the RTP packet will be sent to the real-time data processor 5. The associated PacketStatus for that data packet will then be set to PACKET_READ. If the RTP packet corresponding to SendSeq is not available, no packet is sent to the real-time data processor 5. In any case, SendSeq is incremented by one and the algorithm then enters the data flow adjustment state 40.

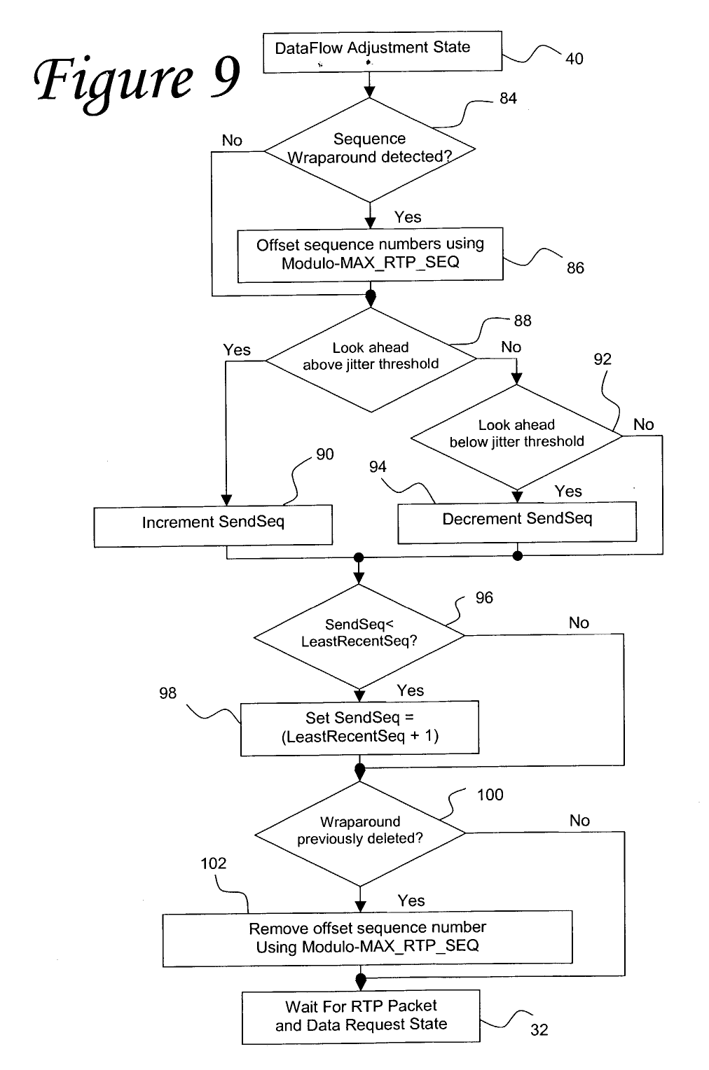

The operation of the jitter buffer algorithm in the data flow adjustment state 40 will now be described with reference to FIG. 9.

In a first step 84 of the data flow adjustment state 40, if it is determined that the algorithm operated in the wraparound mode (indicated by MostRecentSeq<LeastRecentSeq) then in the next step 86, RecvSeq, MostRecentSeq, LeastRecentSeq, and SendSeq will be offset to the non-wraparound ‘region’ by adding Q times of BUF_DEPTH using Modulo MAX_RTP_SEQ, wherein Q is an integer constant. The offset value must be in the range between (MaxDropOut+BUF_DEPTH) and (MAX_RTP_SEQ−1). A next step 88 is then entered. Step 88 is entered directly if no wraparound condition was detected in step 84.

In step 88, the algorithm determines whether SendSeq is less than or equal to (MostRecentSeq−JitterThreshold−Hysteresis). This indicates that the current memory area position being looked at (or read) by the real-time data processor 5 is above the value of JitterThreshold. The next RTP packet to be sent to the real-time data processor 5 will be discarded in step 90 by incrementing SendSeq. If the result of step 88 is “no”, in step 92 it is determined whether SendSeq is greater than (MostRecentSeq−JitterThreshold+Hysteresis), this indicating that the current memory area position being looked at is below the value of JitterThreshold. If this is the case, then the next data request message can be ignored by decrementing the value of SendSeq in step 94.

In step 96, if it is determined that SendSeq is less than LeastRecentSeq, then SendSeq is set to (LeastRecentSeq+1) in step 98. Any offsets introduced by a wraparound condition are detected in step 100 and removed in step 102 by Modulo MAX_RTP_SEQ. The waiting state 32 is then re-entered such that the algorithm waits for a new RTP packet from the IP link 7, or a further data request message from the real-time data processor 5.

Note that a hysteresis band is used in the Jitter Threshold adjustment steps above. Accordingly, the maximum value of JitterMax should not be set greater than (BUF_LEN−Hysteresis−1). Similarly, the minimum value of JitterMin should not be set smaller than (Hysteresis+1).

While the above algorithm is implemented in software running on the processor 13 of the jitter buffer 11, it will be understood that the algorithm could also be implemented in hardware or firmware. The Modulo BUF_DEPTH pigeonholing system could be implemented by masking the least significant bits (LSBs) of the sequence numbers (assuming BUF_DEPTH is a power of two), e.g. masking the last four LSBs for a BUF_DEPTH of 16. The addition of multiple BUF_DEPTH values for handling wraparound can be implemented as a two's complement conversion, again assuming BUF_DEPTH is a power of two.

The above-mentioned algorithm can be adapted to any packet or frame-based network protocol involving sequential sorting of data packets at an output end, and wherein the sequence index is bounded and wraps around to zero when the maximum index is reached.

While at least one presently preferred embodiment of the invention has been described using specific terms, such description is for illustrative purposes only, and it is to be understood that changes and variations may be made without departing from the spirit or scope of the following claims.

What is claimed is:

1. A method of organizing data packets received over a data link, each data packet having associated therewith an index number indicative of the order in which that data packet is required to be outputted, the method comprising the steps of:
providing a buffer having a plurality of memory areas, each memory area being capable of storing a single data packet at a time, and
storing each received data packet in one of the memory areas in accordance with the index number associated with each respective data packet.

2. A method according to claim 1, further comprising the step of:
reading data packets from the respective memory areas in which they are stored in the order in which the data packets are required to be outputted from the buffer.

3. A method according to claim 1, wherein the step of providing a buffer having a plurality of memory areas comprises providing N memory areas and M index numbers, wherein N and M are integers, M>N, and N>1.

4. A method according to claim 3, wherein the step of storing each received data packet in one of the memory areas comprises storing the data packets in the memory areas in accordance with the result of M (Modulo N) where M is the index number associated with each respective data packet.

5. A method according to claim 3, further comprising the steps of:
repeating the index numbers after M data packets have been sent over the data link,
monitoring each received data packet and its associated index number,
determining whether the associated index number of a received packet is a repeat of a previously-received index number, and
adding an integer multiple of N to index numbers of data packets currently stored in the buffer when the step of determining determines that the associated index number of a received packet is a repeat of a previously-received index number.

6. A method according to claim 4, further comprising the steps of:
repeating the index numbers after M data packets have been sent over the data link,
monitoring each received data packet and its associated index number,
determining whether the associated index number of a received packet is a repeat of a previously-received index number, and
adding an integer multiple of N to index numbers of data packets currently stored in the buffer when the step of determining determines that the associated index number of a received packet is a repeat of a previously-received index number.

7. A method according to claim 5, wherein the step of determining whether the associated index number of a received packet is a repeat of a previously-received index number is performed by detecting when the index number of the received data packet is less than the index number of the data packet received directly previously.

8. A method according to claim 3, further comprising the steps of:
monitoring the difference between index numbers of two consecutively-received data packets to determine whether data packets, required to be outputted between the two consecutively-received data packets, have not yet been received, and
determining if a received index number is a repeat of a previously-received index number only if the number of data packets not received exceeds a predetermined number.

9. A method according to claim 8, further comprising the step of resetting the buffer if (a) the number of data packets not received exceeds the predetermined number, and (b) the received index number is not a repeat of a previously-received index number.

10. A method according to claim 1, wherein any successive data packet allocated to an occupied memory area overwrites the data packet previously stored therein.

11. A method according to claim 1, wherein the index number associated with each data packet is indicative of the order in which the respective data packets were inputted to the data link.

12. A computer program residing on a computer-readable medium comprising instructions for causing a computer to perform the method recited in claim 1.

13. A data buffer configured to organize data packets received over a data link, each data packet having an index number associated therewith indicative of the order in which that data packets are to be outputted from the data buffer, the data buffer comprising:
a memory array, said memory array comprising a plurality of memory areas, each memory area being capable of storing a single data packet at a time, and
a processor, said processor directing the received data packets such that each received data packet is stored in a predetermined one of the memory areas in accordance with the index number associated with respective received data packets.

14. A data buffer according to claim 13, further configured to output data packets, stored in the respective memory areas 6f the buffer, in response to a data request signal.

15. A data buffer according to claim 13, wherein said memory array comprises N memory areas arranged to store data packets having M index numbers, wherein N and M are integers, M>N, and N>1.

16. A data buffer according to claim 15, wherein said processor directs the received data packets such that each received data packets is stored in the memory areas in accordance with the result of M (Modulo N).

17. A data buffer according to claim 15, wherein said processor determines whether the index number associated with a received data packet is a repeat of a previously-received index number and adds an integer multiple of N to index numbers of data packets currently stored in the buffer in response to such determination.

18. A data buffer according to claim 16, wherein said processor determines whether the index number associated with a received data packet is a repeat of a previously-received index number and adds an integer multiple of N to index numbers of data packets currently stored in the buffer in response to such determination.

19. A data buffer according to claim 17, wherein said processor determines whether the index number received is a repeat of a previously-received index number by detecting when the index number of the received data packet is less than the index number of the data packet received directly previously.

20. A data buffer according to claim 15, wherein said processor determines whether (a) data packets, required to be outputted between the two consecutively received data packets, have not yet been received, and (b) if a received index number is a repeat of previously-received index number only if the number of data packets not received exceeds a predetermined number.

21. A data buffer according to claim 13, wherein any successive data packet allocated to an occupied memory area overwrites the data packet previously stored therein.
